(19) United States
(12) Patent Application Publication
(10) Pub. No.: US 2011/0234483 A1
(43) Pub. Date: Sep. 29, 2011

(54) GAME CONTROLLER GLOVE

(75) Inventors: HAI LAN, Tu-Cheng (TW); GA-LANE CHEN, Santa Clara, CA (US); YU-BIN WANG, Tu-Cheng (TW)

(73) Assignee: HON HAI PRECISION INDUSTRY CO., LTD., Tu-Cheng (TW)

(21) Appl. No.: 12/888,424

(22) Filed: Sep. 23, 2010

(30) Foreign Application Priority Data
Mar. 23, 2010 (TW) 99108471

(51) Int. Cl. G09G 5/00

(52) U.S. Cl. 345/156

(57) ABSTRACT

A game controller glove includes a main body, a MEMS, and a power supply. The main body includes five finger portions for receiving fingers of a game player's hand. The MEMS includes finger-movement sensors, MEMS sensors, and a processor. The finger-movement sensors are positioned at the finger portions and used for detecting the movements of the fingers. The MEMS sensors are connected to the corresponding finger-movement sensors and used for sensing pressures applied by the corresponding finger-movement sensors, and converting the pressure into electrical signals. The processor is electrically connected to the MEMS sensors and used for obtaining the electrical signals and then restores the electrical signals back to pressure values. The power supply is used for supplying electrical power to the processor.

### BACKGROUND

1. Technical Field

The present disclosure relates to a game controller glove.

2. Description of Related Art

Game players conventionally play games using keyboards or hand-held controllers, which is not convenient and may be limiting.

Therefore, it is desirable to provide a game controller glove that can overcome the above-mentioned limitations.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is a schematic view of a game controller glove, according to an exemplary embodiment;

FIG. 2 is a cross-sectional view of the game controller glove, taken along the line II-II of FIG. 1.

FIG. 3 is a functional block diagram of the game controller glove of FIG. 1.

### DETAILED DESCRIPTION

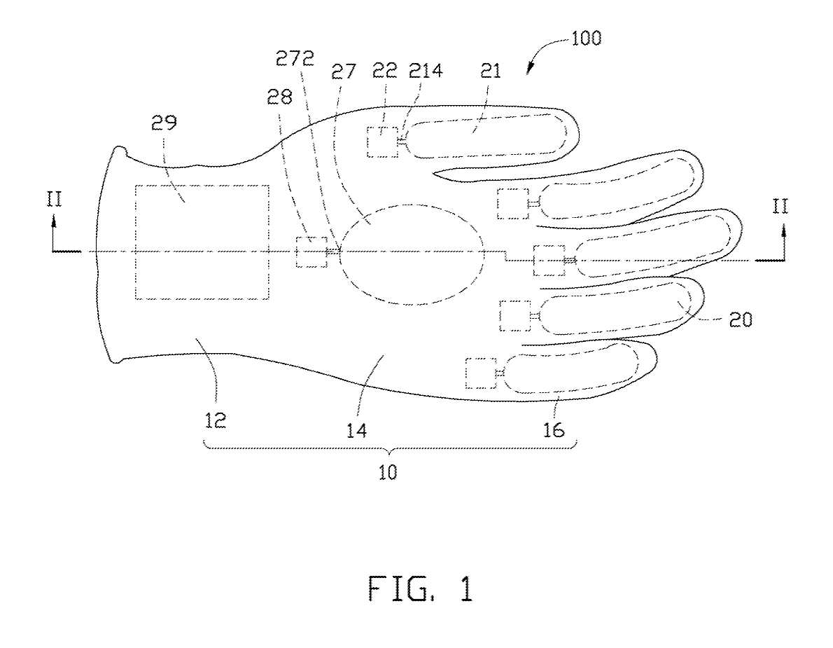

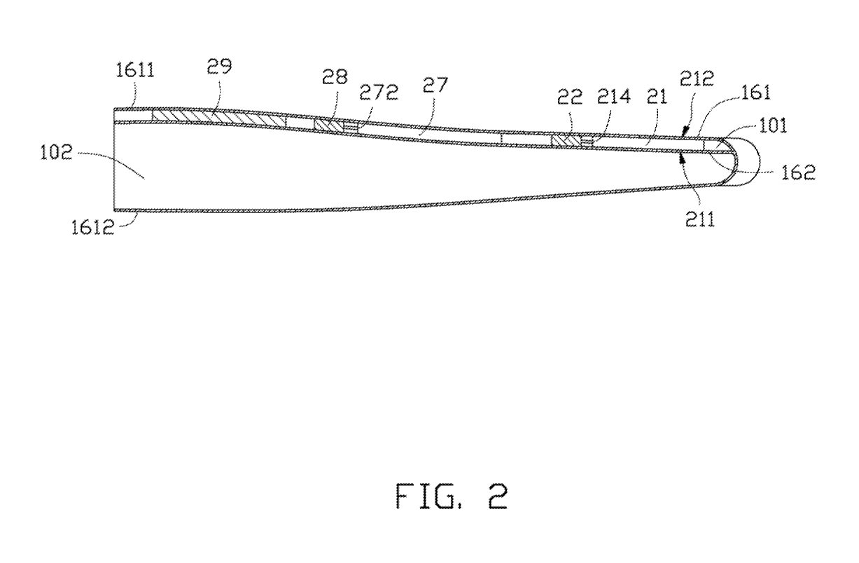

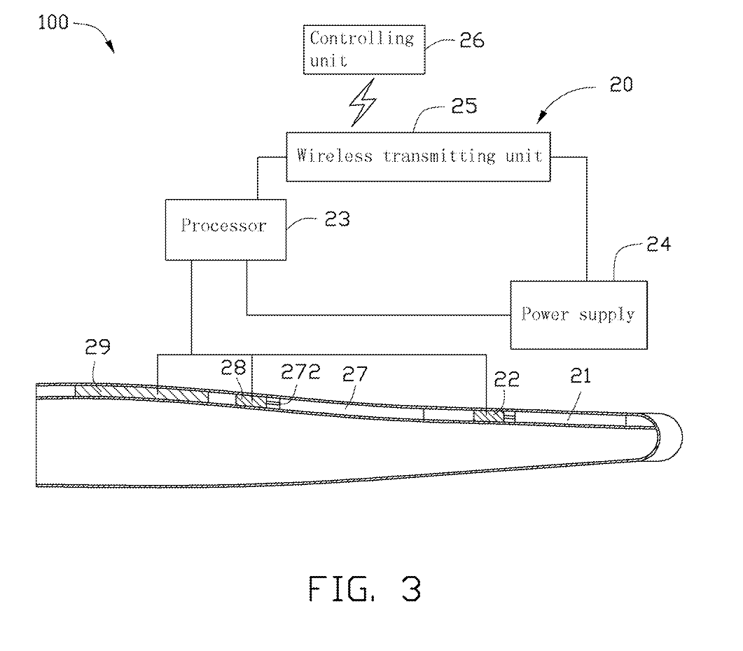

Referring to FIGS. 1-3, a game controller glove 100, according to an exemplary embodiment, includes a main body 10 and a micro-electro-mechanical system (MEMS) 20.

The main body 10 includes a wrist portion 12, a palm portion 14, and five finger portions 16 for respectively encompassing the wrist, the palm, and the five fingers of a game player's hand.

The main body 10 includes a double-layered inner portion 1611 and an outer portion 1612 for respectively encompassing the surface of the game player's hand. The inner portion 1611 includes an upper layer 161 and a bottom layer 162 separated from the upper layer 161, and a first receiving space 101 formed therebetween. The bottom layer 162 and the outer portion 1612 form a second receiving space 102 therebetween for receiving the game player's hand.

The MEMS 20 is used for sensing the movements of the game player' hand and includes five finger-movement sensors 21, five first MEMS sensors 22, a processor 23, and a power supply 24 for supplying electrical power to the processor 23.

The finger-movement sensors 21 are received in the first receiving space 101 at the respective finger portions 16 and used for sensing the movements of the fingers of the game player's hand. Each finger-movement sensor 21 includes a capsule that has a bottom surface 211 and an upper surface 212 opposite to the bottom surface 211. The bottom surface 211 is adhered to the bottom layer 162. The upper surface 212 is adhered to the upper layer 161. The finger-movement sensor 21 is made of elastic material such as rubber and defines a first fluid channel 214. A predetermined volume of fluid such as air or liquid is hermetically sealed and received in the finger-movement sensor 21. In use, for example, when the game player is playing the “rock, paper and scissors” game; and the player makes the “scissors” position with their hand, the index finger and the middle fingers would be straight, and the thumb finger, the ring finger, and the little finger bent. Thus the finger-movement sensors 21 corresponding to the thumb finger, the ring finger, and the little finger are pressed and the fluid in the three corresponding finger-movement sensors 21 compress and pressure builds into the first fluid channels 214. When the “scissor” position is finished, the three finger-movement sensors 21 return to their respective original statuses.

Each first MEMS sensor 22 is connected to a corresponding finger-movement sensor 21 and used for sensing a rise in pressure applied to the fluid in the finger-movement sensor 21 and is used for converting the pressure to electrical signals. In particular, the first MEMS sensor 22 communicates with the first fluid channel 214 by sending pressure into the first fluid channel 214. Specifically, when the finger-movement sensor 21 is pressed, the pressure of the fluid in the first MEMS sensor 22 increases. In this embodiment, the electrical signals can be converted into digital signals. Each first MEMS sensor 22 is arranged in the first receiving space 101, at a joint between the palm portion 14 and a corresponding finger portion 16. Also, the first MEMS sensor 22 can be positioned at the palm portion 14 or other optional positions in the first receiving space 101. In other embodiments, the number of the finger-movement sensors 21 and the first MEMS sensors 22 can fluctuate depending on requirements of the game.

The processor 23 is electrically connected to the first MEMS sensors 22 and used for obtaining the digital signals and then restores the digital signals back to pressure values. In this embodiment, the processor 23 is a micro control unit (MCU). In other embodiments, the processor 23 also can be an application specific integrated circuit (ASIC) or similar technology.

The MEMS sensor 20 further includes a wireless transmitting unit 25 and a control unit 26. The wireless transmitting unit 25 is used for transmitting signals between the processor 23 and the control unit 26. In this embodiment, the wireless transmitting unit 25 is a BLUETOOTH transmitting unit or a Wi-Fi transmitting unit. The power supply 24 is a battery assembly. The power supply 24 is used for supplying electrical power to the wireless transmitting unit 25. The control unit 26 is received in an electronic game or a computer. The control unit 26 receives the pressure signals from the processor 23 and simulates the movements of the player's hand on a display.

The MEMS sensor 20 also includes a palm-movement sensor 27, a second MEMS sensor 28 and a wrist-movement sensor 29. The palm-movement sensor 27 and the second MEMS sensor 28 are received in the first receiving space 101, at the palm portion 14. The wrist-movement sensor 29 is received in the first receiving space 101, at the wrist portion 12. In other embodiments, the palm-movement sensor 27 can be arranged in optional positions in the first receiving space 101 if decided by the player's comfort or game requirements.

The palm-movement sensor 27 also includes a capsule for hermetically sealing a predetermined volume of fluid such as air or liquid. The palm-movement sensor 27 is made of elastic material such as rubber and defines a second fluid channel 272. The second MEMS sensor 28 is connected to the palm-movement sensor 27 and used for sensing a pressure applied by the fluid in the palm-movement sensor 27 and is used for converting the pressure to electrical signals. In particular, the second MEMS sensor 28 communicates with the second fluid channel 272 by sending pressure into the second fluid channel 272. Therefore, when the palm-movement sensor 27 is pressed, the pressure of the fluid on the second MEMS sensor 28 increases. In this embodiment, the electrical signals can be converted into digital signals. The palm-movement sensor 27 can be compared cooperatively with the finger-movement sensors 22 to determine the movements of the player's hands more accurately.

The wrist-movement sensor 29 is used for sensing the movements of the wrist of the game player and then transmitting the sensing signals through the processor 23 and the wireless transmitting unit 25 to the control unit 26. The control unit 26 outputs the sensing signals to the display to simulate the movements of the player's wrist. In this embodiment, the wrist-movement sensor 29 is an infrared ray sensor. In other alternative embodiments, the wrist-movement sensor 29 also can be a photoelectrical sensor, Hall sensor, or other position sensors.

In use, for example, the game controller glove 100 can sense a wide variety of movements and can simulate the player's actions and interactions with the game like applauding movements of the game player's hands or cheering at a “Singapore boxing” match. The game controller glove 100 also can be used in other kinds of games which can require the fingers to bend (e.g. shooting game or baseball game).

It will be understood that the above particular embodiments are shown and described by way of illustration only. The principles and the features of the present disclosure may be employed in various and numerous embodiments thereof without departing from the scope of the disclosure as claimed. The above-described embodiments illustrate the scope of the disclosure but do not restrict the scope of the disclosure.

What is claimed is:

1. A game controller glove comprising:
a main body comprising at least one finger portion configured for receiving at least one finger of a game player; and
an MEMS comprising:
at least one finger-movement sensor arranged in the at least one finger portion and configured for detecting the movements of the at least one finger;
at least one first MEMS sensor connected to the at least one finger-movement sensor and configured for sensing a pressure applied by the at least one finger-movement sensor and converting the pressure to electrical signals;
a processor electrically connected to the at least one first MEMS sensor and configured for obtaining the electrical signals and then restoring the electrical signals back to pressure values; and
a power supply configured for supplying electrical power to the processor.

2. The game controller glove of claim 1, wherein the main body comprises an inner portion and an outer portion.

3. The game controller glove of claim 2, wherein the inner portion is a double-layered configuration and comprises an upper layer, a bottom layer separated from the upper layer, and a first receiving space defined therebetween; the bottom layer and the outer portion define a second receiving space for receiving the game player's hand.

4. The game controller glove of claim 3, wherein both the finger-movement sensor and the first MEMS sensor are received in the first receiving space.

5. The game controller glove of claim 4, wherein the finger-movement sensor comprises a capsule that has a bottom surface and an upper surface opposite to the bottom surface, the bottom surface is adhered to the bottom layer; the upper surface is adhered to the upper layer.

6. The game controller glove of claim 5, wherein the finger-movement sensor is made of elastic material and defines a first fluid channel, a predetermined volume of fluid is hermetically received in the finger-movement sensor.

7. The game controller glove of claim 6, wherein the first MEMS sensor communicates with the first fluid channel by sending pressure into the first fluid channel.

8. The game controller glove of claim 6, wherein the fluid is selected from the group consisting of air and liquid.

9. The game controller glove of claim 3, wherein the main body further comprises a palm portion, the MEMS further comprises a palm movement sensor and a second MEMS sensor, the palm movement sensor is positioned in the first receiving space, at the palm portion, the second MEMS sensor is connected to the palm-movement sensor and configured for sensing a pressure applied by the palm-movement sensor and converting the pressure to electrical signals, the processor is electrically connected to the second MEMS sensor.

10. The game controller glove of claim 9, wherein the palm-movement sensor comprises a capsule hermetically sealing a predetermined volume of fluid, the palm-movement sensor is made of elastic material and defines a second fluid channel.

11. The game controller glove of claim 10, wherein the second MEMS sensor communicates with the second fluid channel by sending pressure into the second fluid channel.

12. The game controller glove of claim 1, wherein the main body comprises a wrist portion, the MEMS further comprises a wrist-movement sensor; the wrist-movement sensor is positioned at the wrist portion and configured for sensing the movements of the wrist of the game player, the processor is electrically connected to the wrist-movement sensor.

13. The game controller glove of claim 12, wherein the wrist-movement sensor is selected from the group consisting of an infrared ray sensor, a photoelectrical sensor, and a Hall sensor.

14. The game controller glove of claim 1, wherein the MESM further comprises a wireless transmitting unit and a control unit; the wireless transmitting unit is configured for transmitting signals between the processor and the control unit; the control unit configured for receiving the pressure values from the processor and simulates the movements of the player's hand on a display.

15. The game controller glove of claim 14, wherein the wireless transmitting unit is selected from the group consisting of a BLUETOOTH transmitting unit and a Wi-Fi transmitting unit.

16. The game controller glove of claim 1, wherein the power supply is a battery assembly.

17. The game controller glove of claim 1, wherein the processor is selected from the group consisting of an MCU and an ASIC.

18. The game controller glove of claim 1, wherein the electrical signals is digital signals.

19. A game controller glove comprising:
a main body comprising five finger portions configured for receiving fingers of a game player;
five finger-movement sensors and configured for detecting the movements of the fingers, each finger-movement sensor positioned on a corresponding finger portion;
five MEMS sensors, each MEMS sensor connected to a corresponding finger-movement sensor and configured for sensing a pressure applied on the corresponding finger-movement sensor and generating an electrical signal representing the pressure; and
a processor electrically connected to the MEMS sensors and configured for obtaining the electrical signals from the MEMS sensors.

20. The game controller glove of claim 19, wherein each finger-movement sensor is a capsule containing a predetermined volume of fluid.
